(19) United States
(12) Patent Application Publication
(10) Pub. No.: US 2025/0056009 A1
(43) Pub. Date: Feb. 13, 2025

(54) CODING CU WITH FOUR-SIDE REFERENCE SAMPLES FOR MPC

(71) Applicant: Nokia Technologies Oy, Espoo (FI)

(72) Inventors: Limin WANG, San Diego, CA (US); Seungwook HONG, San Diego, CA (US); Krit PANUSOPONE, San Diego, CA (US); Jani LAINEMA, Tampere (FI)

(21) Appl. No.: 18/721,281

(22) PCT Filed: Nov. 23, 2022
(86) PCT No.: PCT/EP2022/082900

§ 371 Date: Jun. 18, 2024

Related U.S. Application Data
(60) Provisional application No. 63/291,369, filed on Dec. 18, 2021.

(51) Int. Cl. H04N 19/159; H04N 19/105; H04N 19/176; H04N 19/196

(52) U.S. Cl. CPC H04N 19/159; H04N 19/105; H04N 19/176; H04N 19/196

(57) ABSTRACT

In a system performing encoding or decoding for video, given a coding tree unit with surrounding reference samples on four sides of the coding tree unit, a local prediction block for a current coding unit is built. The local prediction block is used for the encoding or decoding of the video.

### TECHNICAL FIELD

Exemplary embodiments herein relate generally to video and, more specifically, relates to video coding and decoding.

### BACKGROUND

Video files are large, but there are codecs (coder-decoders) that can reduce the size of the video files. Encoding is the process of converting a video from one file format to another. Decoding performs the opposite, taking a file format and outputting video information for a display. There are many different file formats for storing and transmitting video files, and new formats are being proposed.

For instance, the Joint Video Experts Team (JVET) began in April 2018 with the task to develop a new video coding standard. The new video coding standard was named Versatile Video Coding (VVC).

The main benefit of using VVC coding is the ability to stream in 4K. However, it is not exclusively for 4K streaming. As the name suggests, the VVC codec is very versatile. It can support everything from ultra-low to ultra-high-resolution videos. While useful, VVC could still be improved.

### BRIEF SUMMARY

This section is intended to include examples and is not intended to be limiting.

In an exemplary embodiment, a method is disclosed that includes, in a system performing encoding or decoding for video, given a coding tree unit with surrounding reference samples on four sides of the coding tree unit, building a local prediction block for a current coding unit. The method includes using the local prediction block for the encoding or decoding of the video.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus at least to: in a system performing encoding or decoding for video, given a coding tree unit with surrounding reference samples on four sides of the coding tree unit, build a local prediction block for a current coding unit; and use the local prediction block for the encoding or decoding of the video.

An exemplary computer program product includes a computer-readable storage medium bearing computer program code embodied therein for use with a computer. The computer program code includes: code, in a system performing encoding or decoding for video, given a coding tree unit with surrounding reference samples on four sides of the coding tree unit, for building a local prediction block for a current coding unit; and code for using the local prediction block for the encoding or decoding of the video.

In another exemplary embodiment, an apparatus comprises means for performing: in a system performing encoding or decoding for video, given a coding tree unit with surrounding reference samples on four sides of the coding tree unit, building a local prediction block for a current coding unit; and using the local prediction block for the encoding or decoding of the video.

### BRIEF DESCRIPTION OF THE DRAWINGS

In the attached Drawing Figures:

FIG. 1 illustrates a current CU with reference samples on the left and the above;

FIG. 2 illustrates a current CTU that is surrounded by pre-coded reference samples;

FIG. 3 illustrates a current CU is surrounded by reference samples on four sides, in accordance with an exemplary embodiment;

FIG. 4 illustrates a global planar model, in accordance with an exemplary embodiment;

FIG. 5 illustrates a global plane function P (x, y)=3x+2y+100, in accordance with an exemplary embodiment;

FIG. 6 illustrates motion search for a CTU template in reference picture(s), in accordance with an exemplary embodiment;

FIG. 7 illustrates a local planar mode using reference samples on four sides, as in an exemplary embodiment;

FIG. 8 illustrates a local DC mode using reference samples on four sides, in an exemplary embodiment;

FIG. 9 illustrates a local angular mode using reference samples along a prediction direction, in an exemplary embodiment;

FIG. 10 illustrates a local CCLM mode using reference samples on four sides, in an exemplary embodiment;

FIG. 11 illustrates motion search for a CU template in reference picture(s), in accordance with an exemplary embodiment;

FIG. 12 illustrates an alternative derivation of the right and the bottom reference samples of a current CU for local planar mode, in accordance with an exemplary embodiment:

FIG. 13 illustrates an alternative derivation of the right and the bottom reference samples of a current CU for local angular modes;

FIG. 14 illustrates that extended reference samples may be used to derive the right and bottom reference samples of current CU;

FIG. 15 illustrates direct derivation of prediction value of a pixel within a current CU for planar mode, in accordance with an exemplary embodiment;

FIG. 16 illustrates direct derivation of prediction value of a pixel within a current CU for angular mode, in accordance with an exemplary embodiment;

FIG. 17 illustrates the prediction value p is determined from the interpolated extended reference samples t and l, in accordance with an exemplary embodiment;

FIG. 18 is a logic flow diagram for CU Coding with four-side reference samples for MPC;

FIG. 19 is a block diagram of an exemplary encoder, in accordance with an exemplary embodiment;

FIG. 20 is a block diagram of an exemplary decoder, in accordance with an exemplary embodiment; and

FIG. 21 is a block diagram of an exemplary electronic device suitable for implementing the exemplary embodiments, in accordance with an exemplary embodiment.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as either “or”, “and”, or “both”.

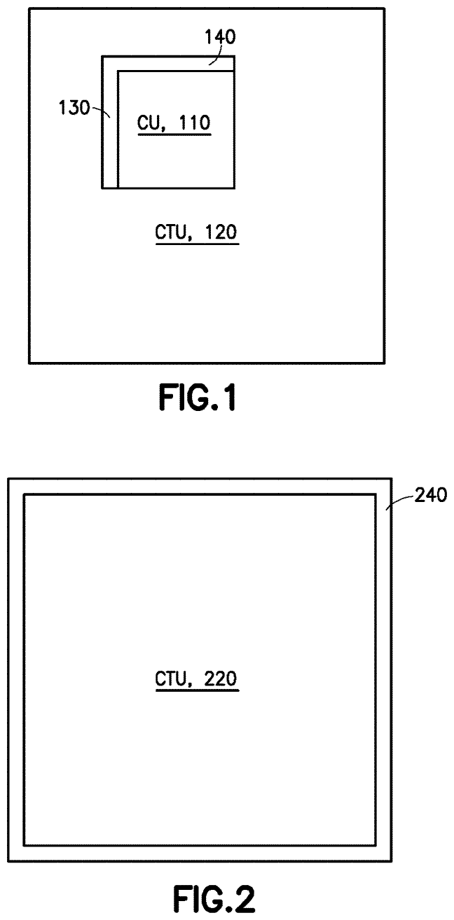

In VVC (Versatile Video Coding), all the coding tools are designed based upon the assumption that (refer to FIG. 1) for a current CU (Coding Unit) 110, its left 130 and above 140 neighboring pixels are already coded, and hence, they can be used as reference samples for coding the current CU. FIG. 1 shows a current CU 110 within a current CTU (Coding Tree Unit) 120, where the left 130 and the above 140 pixels of the current CU 110 are already coded and can be used as reference samples. See, e.g., B. Bross, J. Chen, S. Liu, Y-K Wang, “Versatile Video Coding”, JVET-O2001-vE, June 2020.

On the other hand, in MPC (Massive Parallel Coding), all the boundary pixels of a current CTU are pre-coded and they are available as reference samples for coding the CUs inside the current CTU. This is because one goal of MPC is to code each CTU independently, but with knowledge of reference samples (e.g., pixels 130 and 140). Pre-coded boundary pixels are used to derive these reference samples. Note that the boundary pixels can be either inside or outside the CTU, although FIG. 2 shows an example where a CTU 220 is surrounded by pre-coded reference samples 240 in MPC. Additionally, in MPC, motion information of the boundary pixels of a current CTU can also be available for coding the CUs inside the current CTU.

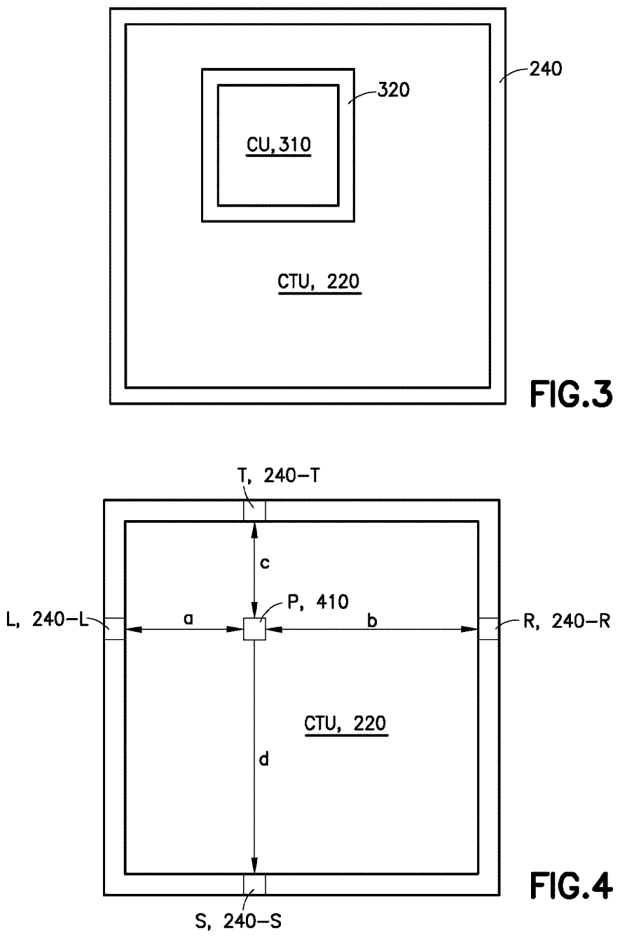

To address these and other issues, with MPC, an exemplary proposal herein is to extend traditional CU coding with two-side reference samples (left and above) to CU coding with four-sided reference samples (where the sides are left, above, right, and bottom). FIG. 3 shows an example where a current CU 310 is surrounded by reference samples 320 on four sides and a CTU 220 is surrounded by reference samples 240 on four sides.

Below, consideration is made of a few possible implementations of CU coding with four-sided reference samples, in accordance with multiple exemplary embodiments.

With respect to joint global and local prediction, consider the following. Given a CTU with surrounding reference samples on four sides, one can first build a global (intra or inter) prediction block for the CTU using the surrounding reference samples, and then for a current CU inside the CTU, one can build a local (intra or inter) prediction block using the reference samples on four sides of the current CU, where the reference samples are derived from the reconstructed neighboring pixels and/or the global prediction block.

With respect to global intra-prediction, possible global intra-prediction modes may include global planar mode, global plane mode, global DC mode (DC mode is a VVC coding tool, where an average of reference samples is the value of every pixel in a prediction block), and the like.

An example of a global planar model is shown in FIG. 4, where L, R, T and S are respectively the left, the right, the above and the bottom reference samples of the current CTU. In detail, the sample value P 410 has the following distances from the reference samples: the distance a from the left (L) reference sample 240-L; the distance b from the right (R) reference sample 240-R: the distance c from the above (T, e.g., for top) reference sample 240-T; and the distance d from the bottom(S) reference sample 240-S. The letter S is used to stand for “bottom”, because the letter b is used below for distances. Similarly, the letter T is used for “above” because the letter a is used below for distances. The sample value P at the location (x,y) of the global prediction block may be defined as the following:

$$P ( x , y ) = ( L \frac{b}{a + b} + R \frac{a}{a + b} ) \cdot {H}_{w} + ( T \frac{d}{c + d} + S \frac{c}{c + d} ) \cdot {V}_{w} ,$$

where

$$L \frac{b}{a + b} and R \frac{a}{a + b}$$

are the contributions of the left and the right reference samples L and R, respectively,

$$T \frac{d}{c + d} and S \frac{c}{c + d}$$

are the contributions of the above and bottom reference samples T and S, respectively,

$$( L \frac{b}{a + b} + R \frac{a}{a + b} )$$

is the total horizontal-sample contribution weighted by H_{w}, and

$$( T \frac{d}{c + d} + S \frac{c}{c + d} )$$

is the total vertical-sample contribution weighted by V_{w}.

For example, in FIG. 4, the horizontal and vertical weights H_{w} and V_{w} may be set as the following:

$${H}_{w} = \frac{min ( c , d )}{min ( a , b ) + min ( c , d )} , and$$

$${V}_{w} = \frac{min ( a , b )}{min ( a , b ) + min ( c , d )} ,$$

where the min (·) is a minimum function that selects a minimum value between two (or more) values.

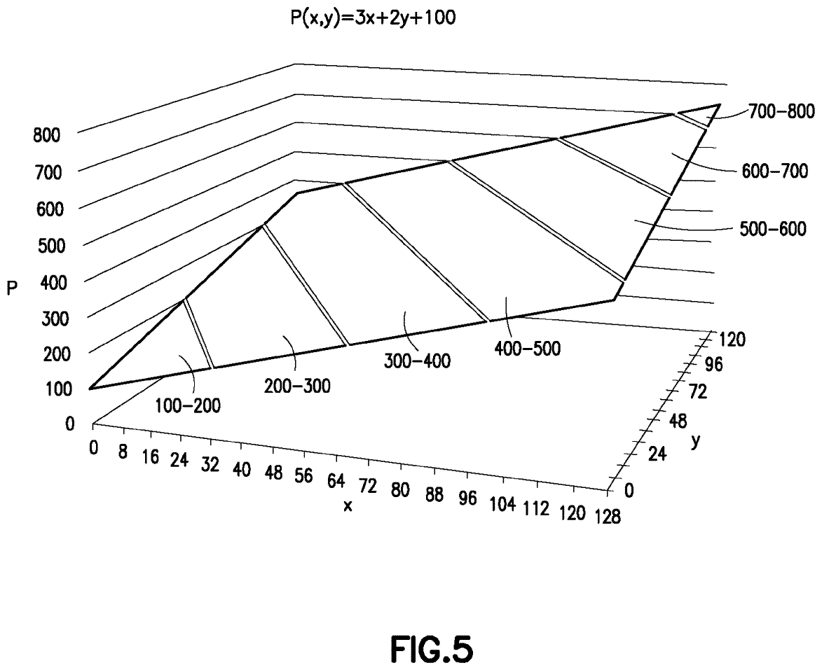

An example of a global plane may have a form as follows:

$$P ( x , y ) = ax + by + c ,$$

where P(x, y) is the sample value at the location (x, y) of the global prediction block, and a, b and c are the coefficients of the global plane. FIG. 5 shows an example of plane function P(x,y)=3x+2y+100, where ranges of values of the plane function are indicated. In this example, the minimum value for P is 100 (as illustrated by the previous equation).

The coefficients of a, b and c of the global plane can be derived using linear regression with the surrounding reference samples on four sides of the current CTU. For example, let zₙ be the value of reference sample at location (xₙ, yₙ), where n covers the surrounding reference samples 240 of the CTU 220, as shown in FIG. 2. The coefficients of a, b and c of the global plane can be calculated using the following:

$$[ \begin{matrix}a \\ b \\ c\end{matrix} ] = {[ \begin{matrix}\sum {x}_{n}^{2} & \sum {x}_{n} {y}_{n} & \sum {x}_{n} \\ \sum {x}_{n} {y}_{n} & \sum {y}_{n}^{2} & \sum {y}_{n} \\ \sum {x}_{n} & \sum {y}_{n} & n\end{matrix} ]}^{- 1} [ \begin{matrix}\sum {z}_{n} {x}_{n} \\ \sum {z}_{n} {y}_{n} \\ \sum {z}_{n}\end{matrix} ] .$$

Global inter-prediction is examined now. Possible global inter-prediction modes may include global template matching and global motion compensation.

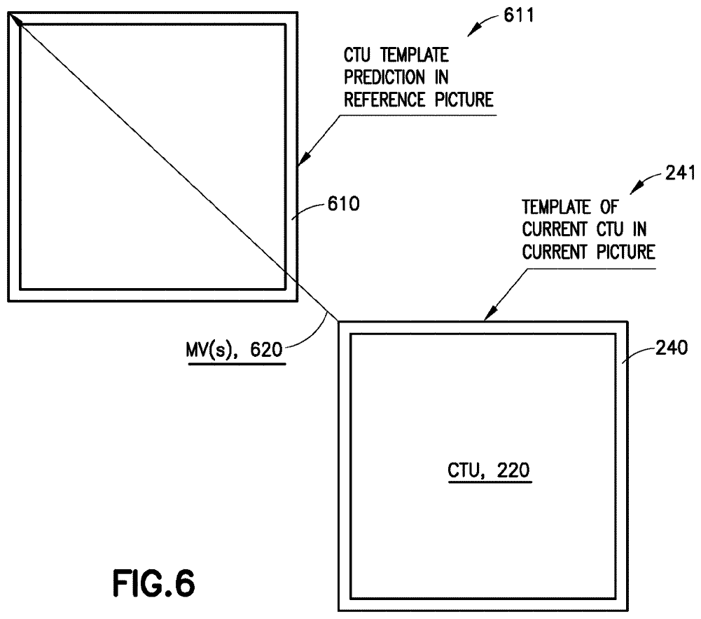

An example of global template matching may use the set of surrounding reference samples 240 on four sides of the current CTU 220 as a global template, and search for a prediction 610 for the global template in reference pictures, where the prediction is pointed to by motion vector(s) MV(s) 620, as shown in FIG. 6. That is, reference 220 indicates the current CTU in FIG. 6, while reference 240 are the reference samples around CTU 220. Reference samples 240 are used as a template 241 for the current CTU 220 in the current picture. Reference 610 is the CTU template prediction 611 for reference samples 240 in the reference picture. Reference 620 is motion vector (MV) pointing at reference 610 from the reference samples 240.

If the same motion search (e.g., the same search algorithm over the same search range of the same reference picture) for the global template for the current CTU is performed at both encoder and decoder, no overhead is needed.

The global template matching MV(s) may be used as the final MV(s) and as motion vector predictor (MVP) for the current CTU. If used as the final MV(s), the prediction block pointed by the global template matching MV(s) is the global inter-prediction block for the current CTU. If used as MVP, an MVD may need to be signaled, similar to AMVP in VVC or the global template match MV(s) may be treated as motion information of a merge mode, similar in VVC.

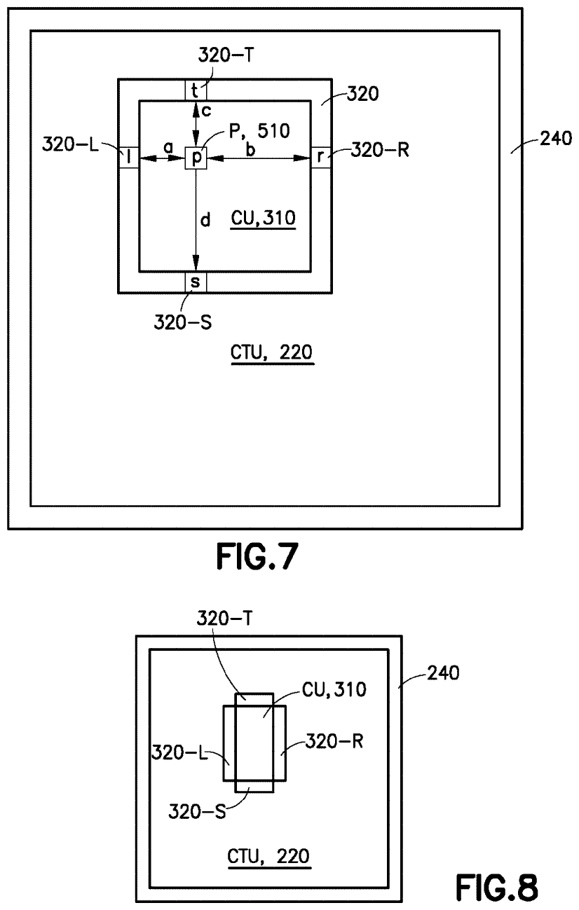

Local intra-prediction examples are described now. When coming to code a current CU inside the CTU in intra mode, one can build a local intra-prediction block for the CU 310 using surrounding reference samples 320 on four sides of the CU 310, as shown in FIG. 7.

Possible local intra modes may include planar, DC, plane, angular, or CCLM modes. Some examples of these are described below.

FIG. 7, for instance, illustrates a local planar mode using reference samples on four sides, as in an exemplary embodiment. The left 320-L and the above 320-T reference samples of the CU 310 are the reconstructed neighboring pixels. The right 320-R and the bottom 320-S reference samples of the CU 310 are obtained from the global prediction block of the current CTU 220 (with its own reference samples 240).

An example of local planar mode is shown in FIG. 7, where l, r, t and s are respectively the left 320-L, the right 320-R, the above 320-T, and the bottom 320-S reference samples of the current CU 310. The sample value p 510 at the location (x, y) of the local prediction block may be defined as the following:

$$p ( x , y ) = ( l \frac{b}{a + b} + r \frac{a}{a + b} ) \cdot {h}_{w} + ( t \frac{d}{c + d} + s \frac{c}{c + d} ) \cdot {v}_{w} ,$$

where

$$l \frac{b}{a + b} and r \frac{a}{a + b}$$

are the contributions of the left and the right reference samples l and r,

$$t \frac{d}{c + d} and s \frac{c}{c + d}$$

are the contributions of the above and the bottom reference samples t and s,

$$( l \frac{b}{a + b} + r \frac{a}{a + b} )$$

is the total horizontal-sample contribution weighted by h_{w}, and

$$( t \frac{d}{c + d} + s \frac{c}{c + d} )$$

is the total vertical-sample contribution weighted by v_{w}.

For example, in FIG. 7, the horizontal and vertical weights h_{w} and v_{w} may be set as the following:

$${h}_{w} = \frac{min ( c , d )}{min ( a , b ) + min ( c , d )} , and$$

$${v}_{w} = \frac{min ( a , b )}{min ( a , b ) + min ( c , d )} .$$

An example of local DC mode is shown in FIG. 8, which illustrates a local DC mode using reference samples on four sides. References 320-L, 320-R, 320-T, and 320-S are respectively the left (L), the right (R), the above (T) and the bottom(S) reference samples 320 of the current CU 310. The sample value p at every position in the local prediction block may be defined as the following:

$$p = \frac{\sum L + \sum R + \sum T + \sum S}{\# L + \# R + \# T + \# S} ,$$

where ΣL, ΣR, ΣT, ΣS are sum of pixel intensities of all left, right, above, and bottom reference samples, respectively, and #L+#R+#T+#S are numbers of left, right, above, and bottom reference samples, respectively.

An alternative DC mode may compute a sample value p at every position in the local prediction block using pixels only from reference samples belong to the side with larger number of pixels, when the current CU 310 is non-square. For example, when height is greater than width, the sample value p 510 at every position in the local prediction block may be defined via the following:

$$p = \frac{\sum L + \sum R}{\# L + \# R} .$$

An example of local plane may have a form as follows:

p(x,y)=ax+by +c,
where p(x, y) is the sample value at the location (x, y) of the local prediction block, and a, b and c are the coefficients of the local plane.

The coefficients of a, b and c of the local plane can be derived using linear regression with the surrounding reference samples on four sides of the current CU. For example, let zₙ be the value of reference sample at location (xₙ, yₙ), where n covers the surrounding reference samples 320 of the CU 220, as shown in FIG. 3. The coefficients of a, b and c of the local plane can be calculated as the following:

$$[ \begin{matrix}a \\ b \\ c\end{matrix} ] = {[ \begin{matrix}\sum {x}_{n}^{2} & \sum {x}_{n} {y}_{n} & \sum {x}_{n} \\ \sum {x}_{n} {y}_{n} & \sum {y}_{n}^{2} & \sum {y}_{n} \\ \sum {x}_{n} & \sum {y}_{n} & n\end{matrix} ]}^{- 1} [ \begin{matrix}\sum {z}_{n} {x}_{n} \\ \sum {z}_{n} {y}_{n} \\ \sum {z}_{n}\end{matrix} ] .$$

For local angular modes, the prediction value of a pixel within a current CU 310 may be derived from the interpolated reference samples along the prediction direction. Note that each prediction direction may have a separate interpolation process. The interpolation process for reference samples in VVC may be one of multiple options. That is, other interpolation processes may also be used.

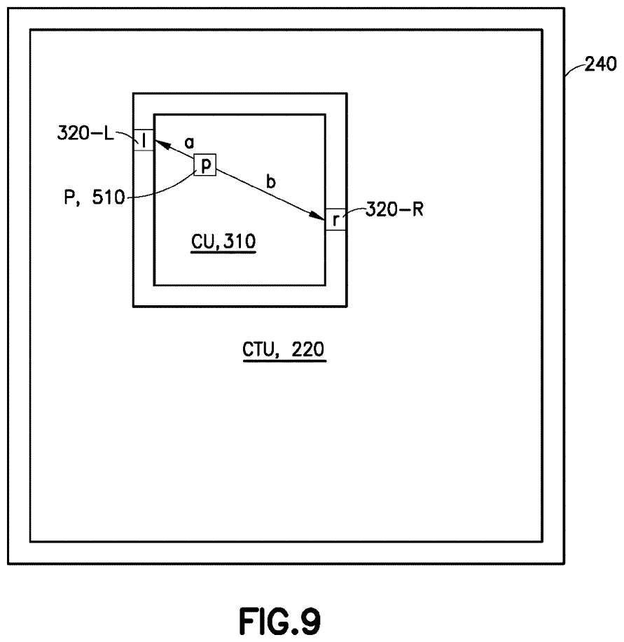

An example of local angular mode is illustrated in FIG. 9, which illustrates a local angular mode using reference samples along a prediction direction. As seen, there are two interpolated reference samples l and r, 320-L and 320-R respectively, along the prediction direction. The sample value p 510 at the location (x, y) of the local prediction block may be defined as the following:

$$p ( x , y ) = ( l \frac{b}{a + b} + r \frac{a}{a + b} ) ,$$

where
a and b are the distances from the interpolated reference sample r and s to the location (x, y), respectively, and

$$l \frac{b}{a + b} and r \frac{a}{a + b}$$

are the contributions of interpolated reference sample r and s, respectively.

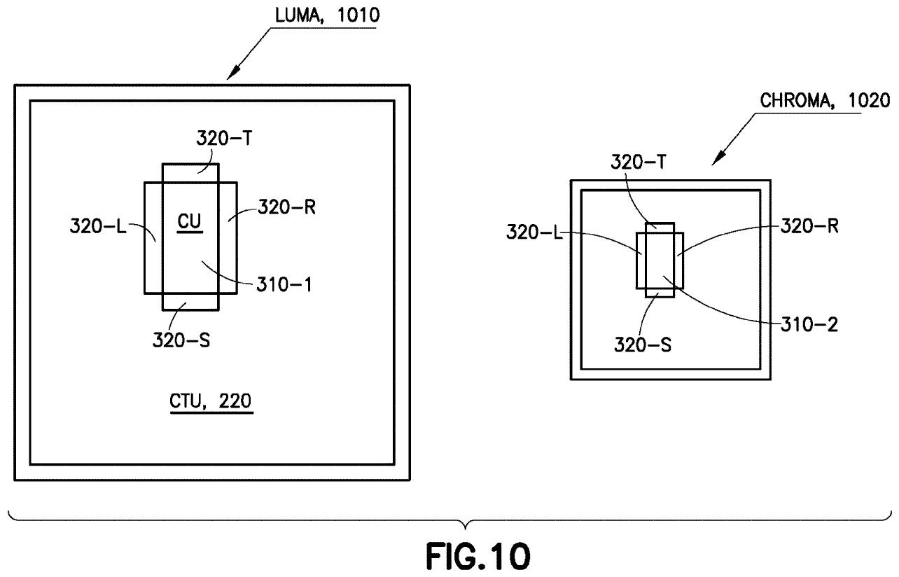

An example of local CCLM (Cross Component Linear Model) prediction is shown in FIG. 10, which illustrates a local CCLM mode using reference samples on four sides, in an exemplary embodiment. The left part 1010 shows current luma CB and the right part 1020 shows current chroma CB. The boxes in both figures are respectively the left (L) 320-L, the right (R) 320-R, the above (T) 320-T, and the bottom(S) 320-S reference samples of the current luma CB 310-1 and chroma CB 310-2. The sample value p at the location (x, y) of the local chroma prediction block 310-2 may be defined as the following:

$$p ( x , y ) = aL ( {x}^{′} , {y}^{′} ) + b ,$$

where p (x, y) is the sample value at the location (x, y) of the local chroma prediction block and L (x′, y′) is the sample value at the co-located location (x′, y′) of the local luma prediction block.

The coefficients of a and b of the local CCLM can be derived using linear regression with the surrounding reference samples on four sides 320 of the current luma and chroma CBs, similar to the method described for the linear plane.

Alternatively, the coefficients of a and b may be computed from a function representing a straight line from intensities of chroma pixels corresponding to luma pixels with highest and lowest intensities among all the left 320-L, the right 320-R, the above 320-T, and the bottom 320-S reference samples of the current luma CB 310-1, which may be computed using the following:

$$a = \frac{{p}_{m} - {p}_{n}}{{L}_{m} + {L}_{n}} ,$$

$$b = {p}_{n} - {aL}_{n} ,$$

where pₘ and Lₘ are intensity of chroma and luma reference samples at a position m, where the intensity of Lₘ is the highest among all the left, the right, the above, and the bottom reference samples of the current luma CB 310-1, and pₙ and Lₙ are intensity of chroma and luma pixels at a position n, where the intensity of Lₙ is the lowest among all the left, the right, the above, and the bottom reference samples of the current luma CB 310-1.

With respect to local inter-prediction, examples of this are described as follows. When coming to code a current CU 310 inside the CTU 220 in inter mode, one can build a local template for the CU 310 using surrounding reference samples 320 on four sides of the CU 310, as shown in FIG. 3. The left and the above reference samples 240 are the reconstructed neighboring pixels. The right and the bottom reference samples 320 are obtained from the global prediction block of the current CTU.

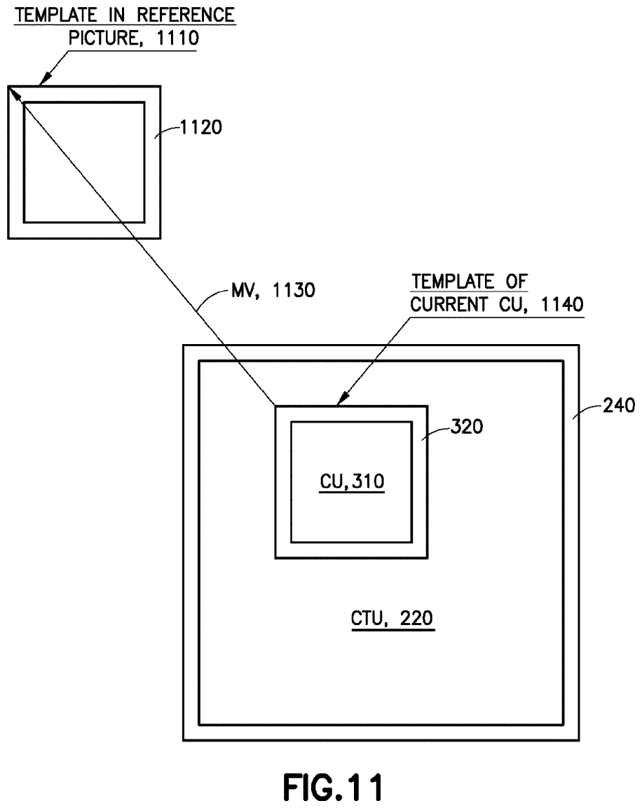

An example of local template matching may use the set of surrounding reference samples 320 on four sides of the current CU 310 as the local template 1140, from which a search is performed for MV(s) 1130 for the local template, as shown in FIG. 11, which illustrates motion search for a CU template in reference picture(s) 1110. That is, the four-side reference samples 320 of the CU 310 CU are used as a template for the CU, and then a search for a best prediction for the template in reference pictures (past coded pictures) is performed.

If the same motion search (e.g., the same search algorithm over the same search range of the same reference picture) for the local template for the current CTU 220 is performed at both encoder and decoder, no overhead is needed.

The local template matching MV(s) 1130 may be used as the final MV(s) and as motion vector predictor (MVP) for the current CU 310. If used as the final MV(s), the prediction block pointed by the local template matching MV(s) is the local inter-prediction block for the current CU 310. If used as MVP, a MVD may need to be signaled, similar to AMVP in VVC, or the local template match MV(s) may be treated as motion information of a merge mode in VVC.

Alternative derivation of the right and the bottom reference samples is now described. In VVC (see B. Bross, J. Chen, S. Liu, Y-K Wang, “Versatile Video Coding”, JVET-O2001-vE, June 2020), CUs within a CTU are coded following Z-order, within which the left and the above reference samples for a current CU are always available. Hence, instead of being obtained from the associated global prediction block, the right and the bottom reference samples for a current CU may be derived from the left and the above reference samples of the current CU and the right and bottom reference samples of the current CTU.

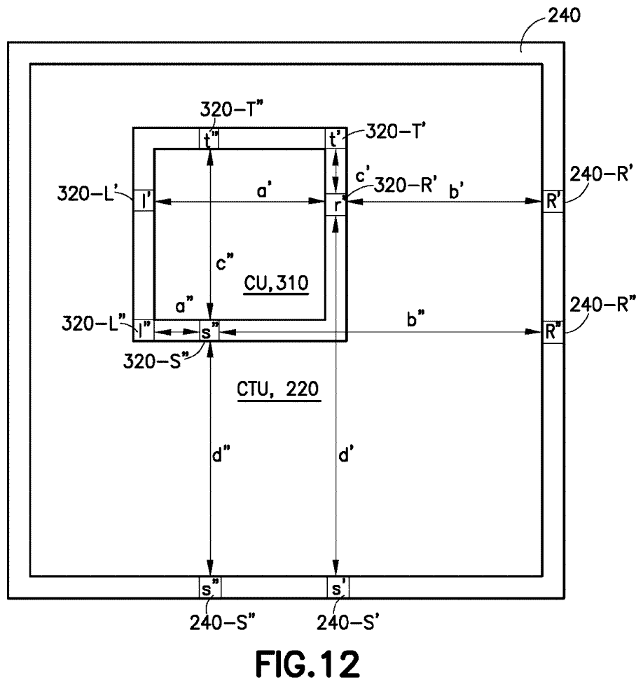

For example, for local DC and local planar modes, the right and the bottom reference samples of a current CU may be derived as shown in FIG. 12, which illustrates an alternative derivation of the right and the bottom reference samples of a current CU for local planar mode, in accordance with an exemplary embodiment. The reference samples include 320-L′, 320-L″, 320-S″, 320-R′, 320-T′, and 320-T″. The reference samples also include 240-R′, 240-R″, 240-S′, and 240-S″. The following distances are shown: a′ between 320-L′ and 320-R′: a″ between 320-L″ and 320-S″: b′ between 320-R′ and 240-R′: b″ between 320-S″ and 240-R″: c′ between 320-T′ and 320-S′: c″ between 320-T″ and 320-S″: d′ between 320-R′ and 240-S′; and d″ between 320-S″ and 240-S″.

In FIG. 12, the right reference sample r′ 320-R′ and the bottom reference sample s″ 320-S″ of the current CU 310 can be calculated respectively as the following:

$${r}^{′} = ( {l}^{′} \frac{{b}^{′}}{{a}^{′} + {b}^{′}} + {R}^{′} \frac{{a}^{′}}{{a}^{′} + {b}^{′}} ) \cdot {h}_{w}^{′} + ( {t}^{′} \frac{{d}^{′}}{{c}^{′} + {d}^{′}} + {S}^{′} \frac{{c}^{′}}{{c}^{′} + {d}^{′}} ) \cdot {v}_{w}^{′} ,$$

$$and$$

$${s}^{″} = ( {l}^{″} \frac{{b}^{″}}{{a}^{″} + {b}^{″}} + {R}^{″} \frac{{a}^{″}}{{a}^{″} + {b}^{″}} ) \cdot {h}_{w}^{″} + ( {t}^{″} \frac{{d}^{″}}{{c}^{″} + {d}^{″}} + {S}^{″} \frac{{c}^{″}}{{c}^{″} + {d}^{″}} ) \cdot {v}_{w}^{″} .$$

For example, in FIG. 12, the horizontal and vertical weights h′_{w}, v′_{w}, h″_{w} and v″_{w} may be set as the following:

$${h}_{w}^{′} = \frac{min ( {c}^{′} , {d}^{′} )}{min ( {a}^{′} , {b}^{′} ) + min ( {c}^{′} , {d}^{′} )} ,$$

$${v}_{w}^{′} = \frac{min ( {a}^{′} , {b}^{′} )}{min ( {a}^{′} , {b}^{′} ) + min ( {c}^{′} , {d}^{′} )} ,$$

$${h}_{w}^{″} = \frac{min ( {c}^{″} , {d}^{″} )}{min ( {a}^{″} , {b}^{″} ) + min ( {c}^{″} , {d}^{″} )} , and$$

$${v}_{w}^{″} = \frac{min ( {a}^{″} , {b}^{″} )}{min ( {a}^{″} , {b}^{″} ) + min ( {c}^{″} , {d}^{″} )} .$$

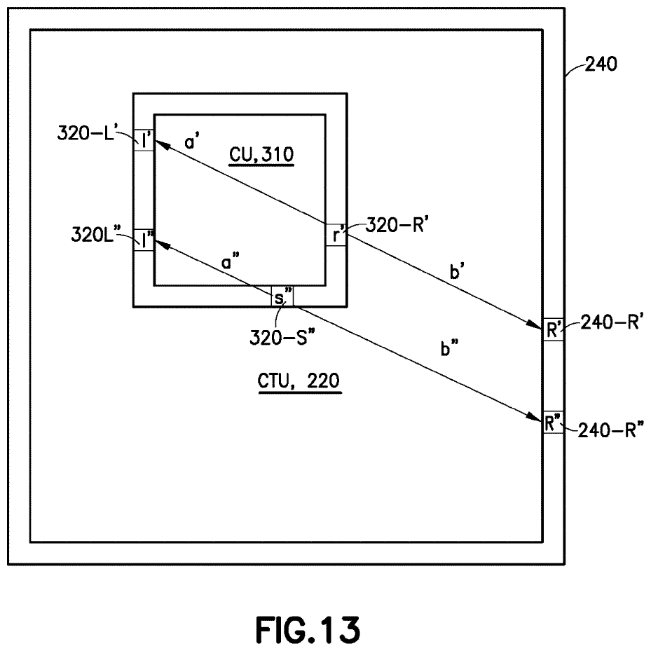

For local angular modes (e.g., indices between 18 and 50 in VVC), the right and the bottom reference samples of a current CU may be derived from the interpolated left/above reference samples of the current CU and/or the interpolated right/bottom reference samples of the current CTU along the angular prediction direction. An example is illustrated in FIG. 13, which illustrates alternative derivation of the right and the bottom reference samples of a current CU for local angular modes. The following distances are shown: a′ between 320-L′ and 320-R′: a″ between 320-L″ and 320-S″: b′ between 320-R′ and 240-R′; and b″ between 320-S″ and 240-R″.

In the example of FIG. 13, the right reference sample r′ and the bottom reference sample s″ of the current CU can be calculated respectively as follows:

$${r}^{′} = ( {l}^{′} \frac{{b}^{′}}{{a}^{′} + {b}^{′}} + {R}^{′} \frac{{a}^{′}}{{a}^{′} + {b}^{′}} ) , and$$

$${s}^{″} = ( {l}^{″} \frac{{b}^{″}}{{a}^{″} + {b}^{″}} + {R}^{″} \frac{{a}^{″}}{{a}^{″} + {b}^{″}} ) ,$$

where
a′ and b′ are the distances from t′ and l′ to R′, and
a″ and b″ are the distances from t″ and l″ to R″.

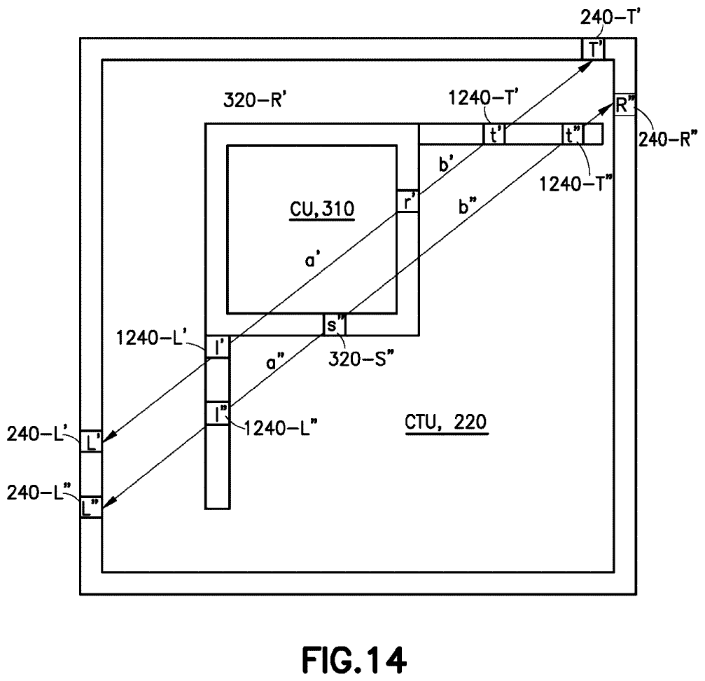

For some CUs, it is possible that their extended above-right and bottom-left reference samples (see 1240-T′/1240-T″ and 1240-L′/1240-L″ of FIG. 14) are available. When in angular modes (e.g., indices between 2 and 17, and indices between 51 and 67 in VVC), if these extended reference samples are closer than the reference samples of CTU to a current CU along the prediction directions, they may be used to determine the right and bottom reference samples of the current CU. FIG. 14 illustrates that extended reference samples 1240-T′, 1240-T″, 1240-L′, and 1240-L″ may be used to derive the right 320-R′ and bottom 320-S″ reference samples of current CU. FIG. 14 shows an example, where, along the angular prediction direction, the interpolated extended above-right and bottom-left reference samples 1240 (t′, t″, l′, and l″) are closer than the interpolated reference samples 240 (T′, R″, L′ and L″) of the current CTU 220 to the current CU 310.

In the example of FIG. 14, the right reference sample r′ is determined from the interpolated extended reference samples of t′ and l′, and the bottom reference sample s″ is determined from the interpolated extended reference samples of t″ and l′ as the following:

$${r}^{′} = ( {l}^{′} \frac{{b}^{′}}{{a}^{′} + {b}^{′}} + {t}^{′} \frac{{a}^{′}}{{a}^{′} + {b}^{′}} ) , and$$

$${s}^{″} = ( {l}^{″} \frac{{b}^{″}}{{a}^{″} + {b}^{″}} + {t}^{″} \frac{{a}^{″}}{{a}^{″} + {b}^{″}} ) ,$$

where
a′ and b′ are the distances from t′ and l′ to r′, and
a″ and b″ are the distances from t″ and l″ to s″.

With respect to direct derivation of prediction value, this is described now. The prediction value p of a pixel within a current CU may even be directly derived from the left and the above reference samples of the current CU and the right and the bottom reference samples of the current CTU.

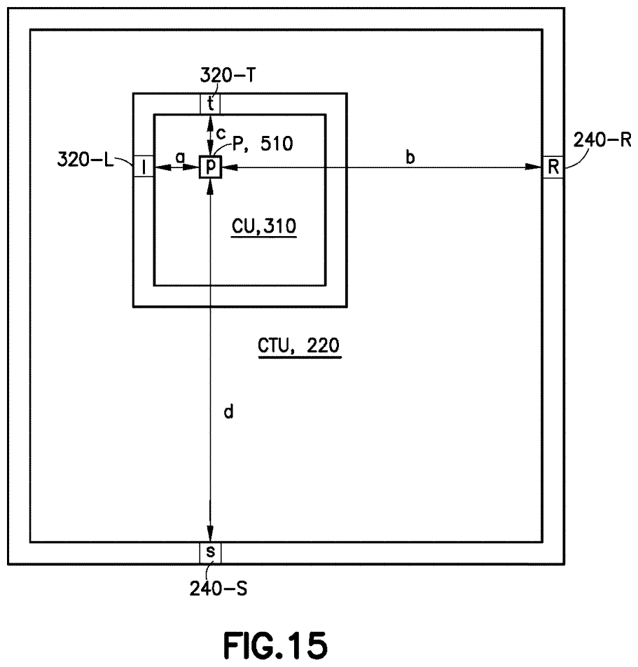

FIG. 15 shows an example of direct planar mode, and illustrates direct derivation of prediction value of a pixel within a current CU for planar mode, in accordance with an exemplary embodiment. In FIG. 15, l and t are the left 320-L and the above 320-T reference samples of the current CU and R and S are the right 240-R and bottom 240-S reference samples of the current CTU. The sample value p 510 at the location (x, y) of the local prediction block can be derived as

$$p ( x , y ) = ( l \frac{b}{a + b} + R \frac{a}{a + b} ) \cdot {h}_{w} + ( t \frac{d}{c + d} + S \frac{c}{c + d} ) \cdot {v}_{w} .$$

For example, in FIG. 15, the horizontal and vertical weights h_{w} and v_{w} may be set as the following:

$${h}_{w} = \frac{min ( c , d )}{min ( a , b ) + min ( c , d )} , and$$

$${v}_{w} = \frac{min ( a , b )}{min ( a , b ) + min ( c , d )} .$$

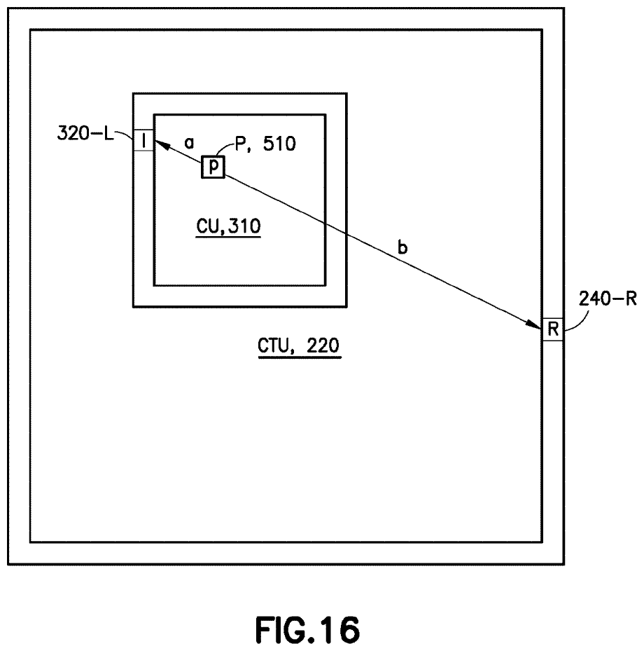

For a specific angular mode (e.g., indices between 18 and 50 in VVC), the prediction value p of a pixel within a current CU 310 may be directly derived from the interpolated left/above reference samples of the current CU 310 and/or the right/bottom reference samples of the current CTU 220 along the angular prediction direction. An example is shown in FIG. 16, which illustrates direct derivation of prediction value of a pixel within a current CU for angular mode, in accordance with an exemplary embodiment.

In FIG. 16, the sample value p 510 at the location (x, y) of the local prediction block is derived from the interpolated left reference sample l 320-L of the current CU 310 and the interpolated right reference sample R 240-R of the current CTU 220 as the following:

$$p ( x , y ) = ( l \frac{b}{a + b} + R \frac{a}{a + b} ) .$$

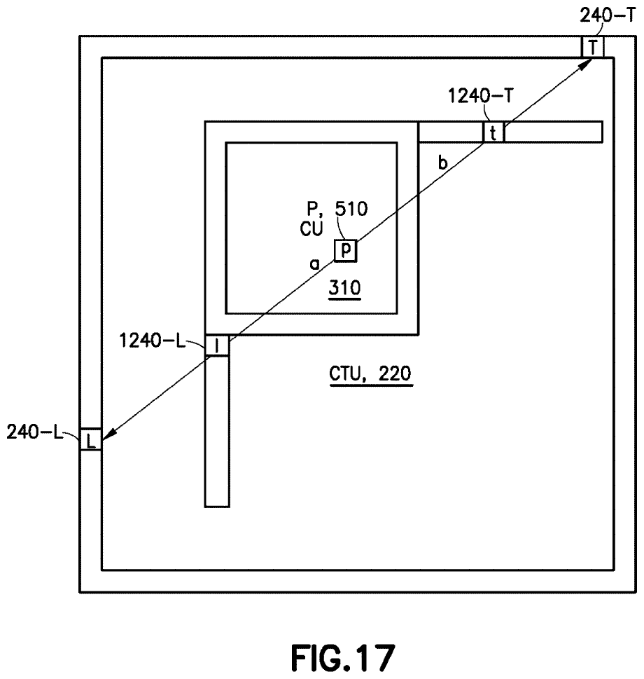

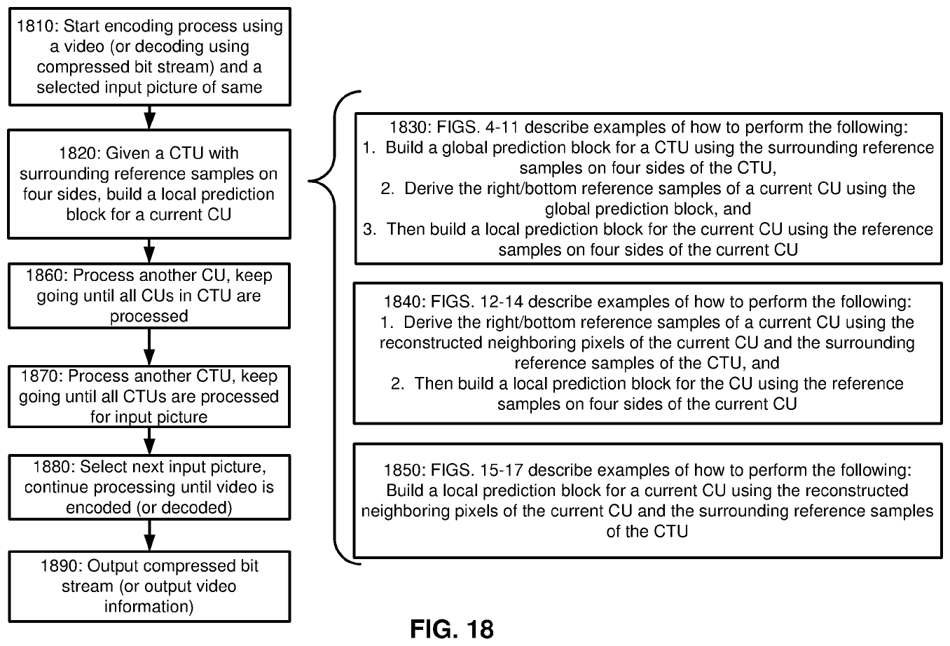

For an angular mode (e.g., indices between 2 and 17, and indices between 51 and 67 in VVC), if the extended reference samples of a current CU along the angular prediction direction are available, they can be used to determine the prediction value p of a pixel within the current CU directly. FIG. 17 shows an example, where this figure illustrates the prediction value p is determined from the interpolated extended reference samples t and l, 1240-T and 1240-L, in accordance with an exemplary embodiment. The prediction value p 510 at the location (x, y) of the local prediction block is determined from the interpolated extended reference samples t and l, 240-T and 240-L, along the angular prediction direction as follows:

$$p ( x , y ) = ( l \frac{b}{a + b} + t \frac{a}{a + b} ) .$$

Turning to FIG. 18, this figure is a logic flow diagram for CU Coding with four-side reference samples for MPC. This figure also illustrates the operation of an exemplary method, a result of execution of computer program instructions embodied on a computer readable memory, functions performed by logic implemented in hardware, and/or interconnected means for performing functions in accordance with an exemplary embodiment. The operations in FIG. 18 may be performed by an electronic device, examples of which are described below.

In step 1810, the electronic device starts an encoding process using a video and a selected input picture (e.g., frame) from the video. Note that a similar process may be used for decoding using a compressed bit stream. In block 1820, the electronic device performs the operation of, given a CTU with surrounding reference samples on four sides, building a local prediction block for a current CU. Block 1820 may be performed via a variety of exemplary implementations, of which blocks 1830, 1840, and 1850 are illustrated as possibilities.

Block 1830 indicates that FIGS. 4-11 describe examples of how to perform the following:
1. Build a global prediction block for a CTU using the surrounding reference samples on four sides of the CTU,
2. Derive the right/bottom reference samples of a current CU using the global prediction block, and
3. Then build a local prediction block for the current CU using the reference samples on four sides of the current CU.

Block 1840 indicates that FIGS. 12-14 describe examples of how to perform the following:
1. Derive the right/bottom reference samples of a current CU using the reconstructed neighboring pixels of the current CU and the surrounding reference samples of the CTU, and
2. Then build a local prediction block for the current CU using the reference samples on four sides of the current CU.

Block 1850 describes that FIGS. 15-17 describe examples of how to perform the following: Build a local prediction block for a current CU using the reconstructed neighboring pixels of the current CU and the surrounding reference samples of the CTU.

In block 1860, the electronic device processes another CU, and keeps going until all CUs in CTU are processed. The electronic device in block 1870 processes another CTU, and keeps going until all CTUs are processed for the input picture. In block 1880, the electronic device selects a next input picture, and continues processing until the video is encoded (or decoded). The electronic device in block 1890 outputs a compressed bit stream of the video (or outputs video information). Note that it is not necessarily to start outputting the compressed bits after a video sequence is completely encoded. It can be much earlier. That is, outputting may be more complicated, such as outputting after every input picture has been encoded/decoded or the like. For example, decoding is often performed in real time, such that images (or sets of images) are processed and video information for individual frames is output, e.g., in interlaced or progressive scan format.

The next three figures are devoted to possible encoders, decoders, and apparatus. Before proceeding to describe these figures, it is helpful to review video encoding and decoding. As part of this introduction, a video codec consists of an encoder that transforms the input video into a compressed representation suited for storage/transmission and a decoder that can decompress the compressed video representation back into a viewable form. A video encoder and/or a video decoder may also be separate from each other, i.e., need not form a codec. Typical encoders discard some information in the original video sequence in order to represent the video in a more compact form (that is, at lower bitrate).

Typical hybrid video encoders, for example many encoder implementations of ITU-T H.263 and H.264, encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e., the difference between the predicted block of pixels and the original block of pixels, is coded. This is typically performed by transforming the difference in pixel values using a specified transform (e.g., a Discrete Cosine Transform (DCT) or a variant of it), quantizing the coefficients and entropy coding the quantized coefficients. By varying the fidelity of the quantization process, the encoder can control the balance between the accuracy of the pixel representation (picture quality) and size of the resulting coded video representation (file size or transmission bitrate).

In temporal prediction, the sources of prediction are previously decoded pictures (also known as reference pictures, or reference frames). In intra block copy (IBC: also known as intra-block-copy prediction and current picture referencing), prediction is applied similarly to temporal prediction but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter-prediction may refer to temporal prediction only, while in other cases inter-prediction may refer collectively to temporal prediction and any of intra block copy, inter-layer prediction, and inter-view prediction provided that they are performed with the same or similar process as temporal prediction. Inter-prediction or temporal prediction may sometimes be referred to as motion compensation or motion-compensated prediction.

Inter-prediction, which may also be referred to as temporal prediction, motion compensation, or motion-compensated prediction, reduces temporal redundancy. In inter-prediction the sources of prediction are previously decoded pictures. Intra-prediction utilizes the fact that adjacent pixels within the same picture are likely to be correlated. Intra-prediction can be performed in the spatial or transform domain. i.e., either sample values or transform coefficients can be predicted. Intra-prediction is typically exploited in intra coding, where no inter-prediction is applied.

One outcome of the coding procedure is a set of coding parameters, such as code modes, motion vectors, reference pictures, and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra-prediction may be collectively referred to as in-picture prediction.

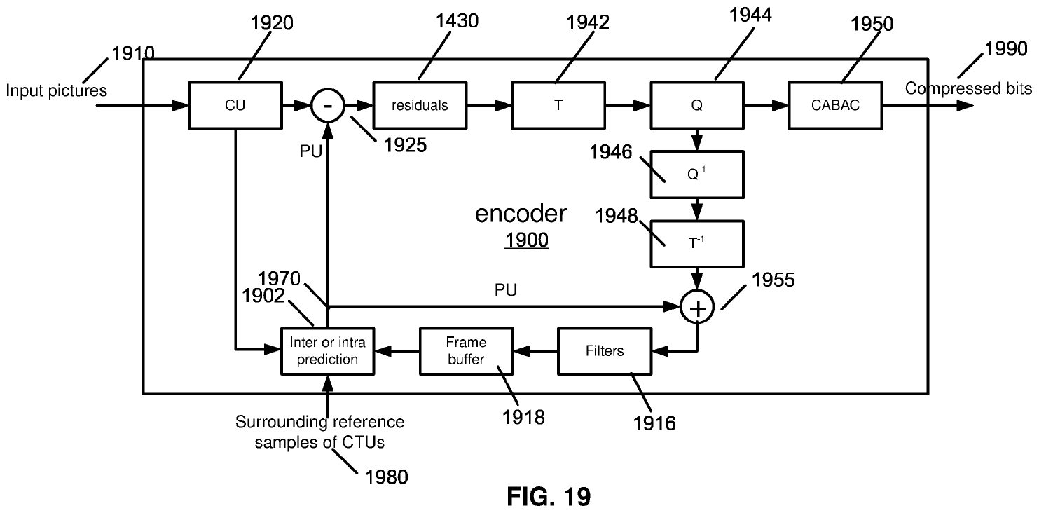

Now that an introduction to this technical area has been made, and turning to FIG. 19, a block diagram is illustrated of an exemplary encoder, in accordance with an exemplary embodiment. The encoder 1900 comprises a CU 1920, an adder 1925 (which performs subtraction), a set of residuals 1430, a transform (T) unit 1942, a quantizer (Q) 1944, a CABAC unit 1950, a dequantizer (Q⁻¹) 1946, an inverse transformation unit (T⁻¹) 1948, an adder 1955 (which performs addition), a set of filters 1916, a frame buffer 1918, and a predictor 1902 supporting one or both of inter- or intra-prediction. The inputs include input pictures 1910 (e.g., frames of video) and surrounding reference samples of CTUs 1980, and the output is a compressed bit stream, illustrated as compressed bits 1990. The surrounding reference samples of CTUs 1980 may be multiple versions of the pre-coded reference samples 240 for different CTUs 220.

The input pictures 1910 are operated on by the CU 1920, where an input picture is divided into CTUs and each CTU is further partitioned into CUs. The output of the CU 1920 is applied to the predictor 1902, where the CU 1920 is determined to be encoded by one or both of the inter-prediction (which determines a temporal prediction for the CU, and associated motion vector(s) and reference picture(s)) and intra-prediction (which determines a spatial prediction for the CU based only on the already processed parts of the current frame or picture). The output (PU 1970) of the predictor 1902 is passed to adders 1925 and 1955.

The adder 1925 subtracts the PU 1970 from the output of the CU 1920, and the output of the adder 1925 may be considered to be a prediction error signal, which forms a set of residuals 1430. The residuals are applied to the transform (T) unit 1942 and then to the quantizer (Q) 1944. The transform (T) unit 1942 and the quantizer (Q) 1944 may be considered to perform prediction error coding. The transform unit 1942 transforms the signal of the residuals 1430 from a spatial domain to a transform domain. The transform is, for example, the DCT transform. The quantizer 1944 quantizes the transform domain signal, e.g., the DCT coefficients, to form quantized coefficients. The CABAC unit 1950 performs a form of entropy encoding, such as that used in the H.264/MPEG-4 AVC and High Efficiency Video Coding (HEVC) standards. That is, the CABAC unit 1950 performs a suitable entropy encoding on the signal from the quantizer 1944 to provide further data compression. The output of the CABAC unit 1950 may be inserted into a bitstream as compressed bits 1990.

The output of the quantizer 1944 is also directed to the dequantizer 1946, which dequantizes the quantized coefficient values, e.g., DCT coefficients, to reconstruct the transform signal and subsequently directed to an inverse transformation unit 1948, which performs the inverse transformation to the reconstructed transform signal wherein the output of the inverse transformation unit 1948 contains reconstructed residual block(s). The dequantizer 1946 and the inverse transformation unit 1948 may be considered to be a prediction error decoder, which performs the opposite processes of the prediction error encoder to produce a decoded prediction error signal at the output of the inverse transformation unit 1948, which, when combined with the prediction representation of the image block at the adder 1955, produces a preliminary reconstructed image block that is applied to filters 1916. The filters 1916 filter the reconstructed block(s) according to further decoded information and filter parameters.

The filters 1916 receiving the preliminary representation filter the preliminary representation and output a final reconstructed image, which may be saved in a frame buffer 1918. The frame buffer 1918 is connected to the predictor 1902 to be used as reference image(s) against which the CU 1920 of a future input picture 1910 is compared in, e.g., inter-prediction operations. The predictor 1902 performs inter- and/or intra-prediction using the output of the frame buffer 1918, the CU 1920, and the surrounding reference samples of CTUs 1980.

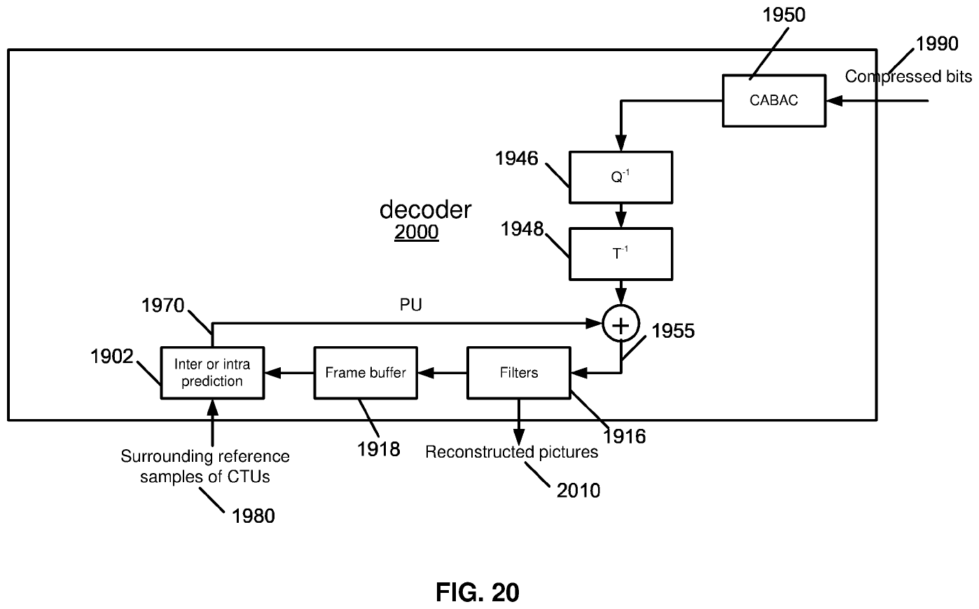

Referring to FIG. 20, this figure is a block diagram of an exemplary decoder, in accordance with an exemplary embodiment. All of the blocks in the block diagram have already been described with reference to FIG. 19, so only differences will be described herein. The compressed bits 1990, e.g., as part of a compressed bit stream, are applied to the CABAC unit 1950, which decompresses the received compressed bits and produces the output applied to the dequantizer 1946. The flow continues through the inverse transform 1948, the adder 1955, and the filters 1916, which produce an output of reconstructed pictures 2010 as output video information. As with FIG. 19, there is a pathway through the filters 1916, the frame buffer 1918, the predictor 1902, and the PU 1970 to the adder 1955. In this example, the predictor 1902 uses the inputs of the surrounding reference samples of CTUs 1980 and the output of the frame buffer 1918 along with other coding information received from encoder, such as code mode, motion vectors, reference picture indices, to form the PU 1970.

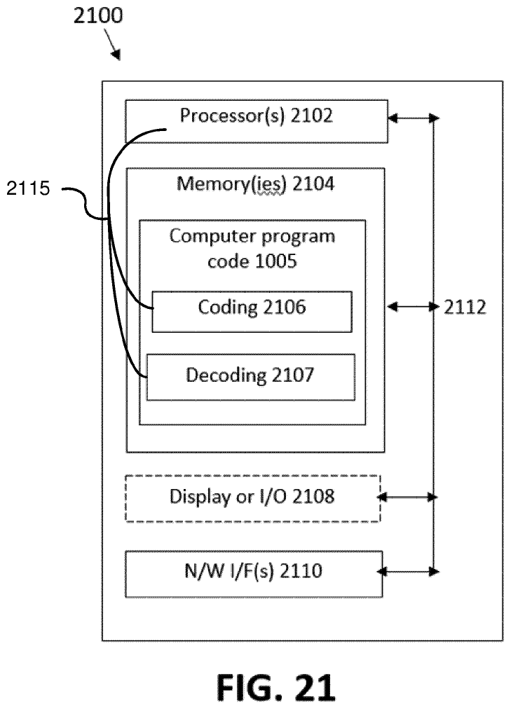

Turning to FIG. 21, this figure is a block diagram of an exemplary electronic device suitable for implementing the exemplary embodiments, in accordance with an exemplary embodiment. The electronic device 2100 is an apparatus comprising one or more processors 2102, one or more memories 2104 including computer program code 2105, wherein the one or more memories 2104 and the computer program code 2105 are configured to, with the at least one processor 2102, cause the electronic device to implement coding 2106 and/or decoding 2107, based on the examples described herein. The electronic device 2100 optionally includes a display or I/O 2108 that may be used to display content during coding 2106 and/or decoding 2107, or receive user input from for example a keypad (not shown). The electronic device 2100 includes one or more network (N/W) interfaces (I/F(s)) 2110. The N/W I/F(s) 2110 may be wired and/or wireless and communicate over the Internet/other network(s) via any communication technique. The N/W I/F(s) 2110 may comprise one or more transmitters and one or more receivers. The N/W I/F(s) 2110 may comprise standard well-known components such as an amplifier, filter, frequency-converter, (de) modulator, and encoder/decoder circuitry (ies) and one or more antennas.

In some examples, the processor(s) 2102 is configured to partially or completely implement the coding 2106 or decoding 2107 without use of memory 2104. This is illustrated by lines 2115, indicating the coding 2106 or decoding 2107. For instance, the coding 2106 could be the encoder 1900 in FIG. 19, and the decoding 2017 could be decoder 2000 in FIG. 19, or parts thereof. These could also be implemented via other hardware, such as ASICs (application-specific integrated circuits), programmable hardware, and the like. Although coding 2106 and decoding 2107 are shown as separate items, they may be combined as one item, block, or unit to form a codec.

The electronic device may also perform or contain only one of the coding 2106 and not the other. For instance, a server might only encode via coding 2106, and a smartphone may only decode and perform the decoding 2107.

The memory (ies) 2104 may be implemented using any suitable data storage technology, such as semiconductor-based memory devices, flash memory, magnetic memory devices and systems, optical memory devices and systems, fixed memory and removable memory. The memory (ies) 2104 may comprise a database for storing data. The memory 2104 may be volatile or non-volatile. Interface 2112 enables data communication between the various items of electronic devices 2100, as shown in FIG. 21. Interface 2112 may be one or more buses, such as address, data, or control buses, and may include any interconnection mechanism, such as a series of lines on a motherboard or integrated circuit, fiber optics or other optical communication equipment, and the like. The electronic device 2100 need not comprise each of the features mentioned, or may comprise other features as well. The electronic device 2100 may be an embodiment of any of the encoders or decoders shown above, including coding 2106 and/or decoding 2017 that implement any of the examples in the figures.

Additional examples include the following:

Example 1. A method, comprising:
in a system performing encoding or decoding for video, given a coding tree unit with surrounding reference samples on four sides of the coding tree unit, building a local prediction block for a current coding unit; and
using the local prediction block for the encoding or decoding of the video.

Example 2. The method of example 1, wherein building a local prediction block for a current coding unit uses reference samples on four sides of the current coding unit.

Example 3. The method of example 2, wherein the reference samples on four sides of the current coding unit are derived from reconstructed neighboring pixels of the current coding unit and/or a global prediction block.

Example 4. The method of example 3, wherein the global prediction block is built using the surrounding reference samples of the coding tree unit.

Example 5. The method of example 2, wherein the reference samples on four sides of the current coding unit are derived from reconstructed neighboring pixels of the current coding unit and/or the surrounding reference samples of the coding tree unit.

Example 6. The method of example 5, wherein right and the bottom reference samples for the current coding unit are derived from left and above reference samples of the current coding unit and right and bottom reference samples of the coding tree unit.

Example 7. The method of example 1, wherein building a local prediction block for the current coding unit uses reconstructed neighboring pixels of the current coding unit and/or the surrounding reference samples of the coding tree unit.

Example 8. The method of example 7, wherein a prediction value of a pixel within the current coding unit is directly derived from left and above reference samples of the current coding unit and right and bottom reference samples of the coding tree unit.

Example 9. A computer program, comprising code for performing the methods of any of examples 1 to 8, when the computer program is run on a computer.

Example 10. The computer program according to example 9, wherein the computer program is a computer program product comprising a computer-readable medium bearing computer program code embodied therein for use with the computer.

Example 11. The computer program according to example 9, wherein the computer program is directly loadable into an internal memory of the computer.

Example 12. An apparatus, comprising means for performing:
in a system performing encoding or decoding for video, given a coding tree unit with surrounding reference samples on four sides of the coding tree unit, building a local prediction block for a current coding unit; and
using the local prediction block for the encoding or decoding of the video.

Example 13. The apparatus of example 12, wherein building a local prediction block for a current coding unit uses reference samples on four sides of the current coding unit.

Example 14. The apparatus of example 13, wherein the reference samples on four sides of the current coding unit are derived from reconstructed neighboring pixels of the current coding unit and/or a global prediction block.

Example 15. The apparatus of example 14, wherein the global prediction block is built using the surrounding reference samples of the coding tree unit.

Example 16. The apparatus of example 13, wherein the reference samples on four sides of the current coding unit are derived from reconstructed neighboring pixels of the current coding unit and/or the surrounding reference samples of the coding tree unit.

Example 17. The apparatus of example 16, wherein right and the bottom reference samples for the current coding unit are derived from left and above reference samples of the current coding unit and right and bottom reference samples of the coding tree unit.

Example 18. The apparatus of example 12, wherein building a local prediction block for the current coding unit uses reconstructed neighboring pixels of the current coding unit and/or the surrounding reference samples of the coding tree unit.

Example 19. The apparatus of example 18, wherein a prediction value of a pixel within the current coding unit is directly derived from left and above reference samples of the current coding unit and right and bottom reference samples of the coding tree unit.

Example 20. The apparatus of any preceding apparatus example, wherein the means comprises:
at least one processor; and
at least one memory including computer program code, the at least one memory and computer program code configured to, with the at least one processor, cause the performance of the apparatus.

Example 21. An apparatus, comprising:
one or more processors; and
one or more memories including computer program code,
wherein the one or more memories and the computer program code are configured, with the one or more processors, to cause the apparatus to:
in a system performing encoding or decoding for video, given a coding tree unit with surrounding reference samples on four sides of the coding tree unit, build a local prediction block for a current coding unit; and
use the local prediction block for the encoding or decoding of the video.

Example 22. The apparatus of example 21, wherein building a local prediction block for a current coding unit uses reference samples on four sides of the current coding unit.

Example 23. The apparatus of example 22, wherein the reference samples on four sides of the current coding unit are derived from reconstructed neighboring pixels of the current coding unit and/or a global prediction block.

Example 24. The apparatus of example 23, wherein the global prediction block is built using the surrounding reference samples of the coding tree unit.

Example 25. The apparatus of example 22, wherein the reference samples on four sides of the current coding unit are derived from reconstructed neighboring pixels of the current coding unit and/or the surrounding reference samples of the coding tree unit.

Example 26. The apparatus of example 25, wherein right and the bottom reference samples for the current coding unit are derived from left and above reference samples of the current coding unit and right and bottom reference samples of the coding tree unit.

Example 27. The apparatus of example 21, wherein building a local prediction block for the current coding unit uses reconstructed neighboring pixels of the current coding unit and/or the surrounding reference samples of the coding tree unit.

Example 28. The apparatus of example 27, wherein a prediction value of a pixel within the current coding unit is directly derived from left and above reference samples of the current coding unit and right and bottom reference samples of the coding tree unit.

Example 29. A computer program product comprising a computer-readable storage medium bearing computer program code embodied therein for use with a computer, the computer program code comprising:
code, in a system performing encoding or decoding for video, given a coding tree unit with surrounding reference samples on four sides of the coding tree unit, for building a local prediction block for a current coding unit; and
code for using the local prediction block for the encoding or decoding of the video.

Example 30. The computer program product of example 29, wherein the computer program code comprises code for performing any of the methods in examples 2 to 8.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 21. A computer-readable medium may comprise a computer-readable storage medium (e.g., memories 2104 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects are set out above, other aspects comprise other combinations of features from the described embodiments, and not solely the combinations described above.

It is also noted herein that while the above describes example embodiments of the invention, these descriptions should not be viewed in a limiting sense. Rather, there are several variations and modifications which may be made without departing from the scope of the present invention.

The following abbreviations that may be found in the specification and/or the drawing figures are defined as follows:
AMVP Adaptive Motion Vector Prediction
CABAC context-based adaptive binary arithmetic coding
CCLM Cross-Component Linear Model
codec coder-decoder
CTU Coding Tree Unit
CU Coding Unit
DCT discrete cosine transform
JVET Joint Video Experts Team
MPC Massive Parallel Coding
MV Motion Vector
MVD Motion Vector Difference
MVP Motion Vector Predictor
PU Prediction Unit
VVC Versatile Video Coding

1-29. (canceled)

30. A method, comprising:
performing encoding or decoding for a video, given a coding tree unit with surrounding reference samples on four sides of the coding tree unit, for building a local prediction block for a current coding unit; and
using the local prediction block for the encoding or decoding of the video.

31. The method of claim 30, wherein building a local prediction block for the current coding unit comprises using reference samples on four sides of the current coding unit.

32. The method of claim 31, wherein the reference samples on the four sides of the current coding unit are derived from reconstructed neighboring pixels of the current coding unit and/or a global prediction block.

33. The method of claim 32, wherein the global prediction block is built using the surrounding reference samples of the coding tree unit.

34. The method of claim 31, wherein the reference samples on the four sides of the current coding unit are derived from reconstructed neighboring pixels of the current coding unit and/or the surrounding reference samples of the coding tree unit.

35. The method of claim 34, wherein right and bottom reference samples for the current coding unit are derived from left and above reference samples of the current coding unit and right and bottom reference samples of the coding tree unit.

36. The method of claim 30, wherein building the local prediction block for the current coding unit uses reconstructed neighboring pixels of the current coding unit and/or the surrounding reference samples of the coding tree unit.

37. The method of claim 36, wherein a prediction value of a pixel within the current coding unit is directly derived from left and above reference samples of the current coding unit and right and bottom reference samples of the coding tree unit.

38. An apparatus, comprising:
one or more processors; and
one or more memories including computer program code,
wherein the one or more memories and the computer program code are configured, with the one or more processors, to cause the apparatus to:
perform encoding or decoding for a video, given a coding tree unit with surrounding reference samples on four sides of the coding tree unit, for
build a local prediction block for a current coding unit; and
use the local prediction block for the encoding or decoding of the video.

39. The apparatus of claim 38, wherein the apparatus upon execution further cause: build a local prediction block for the current coding unit using reference samples on four sides of the current coding unit.

40. The apparatus of claim 39, wherein the reference samples on the four sides of the current coding unit are derived from reconstructed neighboring pixels of the current coding unit and/or a global prediction block.

41. The apparatus of claim 40, wherein the global prediction block is built using the surrounding reference samples of the coding tree unit.

42. The apparatus of claim 39, wherein the reference samples on the four sides of the current coding unit are derived from reconstructed neighboring pixels of the current coding unit and/or the surrounding reference samples of the coding tree unit.

43. The apparatus of claim 42, wherein right and bottom reference samples for the current coding unit are derived from left and above reference samples of the current coding unit and right and bottom reference samples of the coding tree unit.

44. The apparatus of claim 38, wherein upon execution the apparatus further cause: build the local prediction block for the current coding unit using reconstructed neighboring pixels of the current coding unit and/or the surrounding reference samples of the coding tree unit.

45. The apparatus of claim 44, wherein a prediction value of a pixel within the current coding unit is directly derived from left and above reference samples of the current coding unit and right and bottom reference samples of the coding tree unit.

46. A computer program product comprising a computer-readable storage medium bearing computer program code embodied therein for use with a computer, the computer program code comprising:
perform encoding or decoding for video, given a coding tree unit with surrounding reference samples on four sides of the coding tree unit for building a local prediction block for a current coding unit; and
code for using the local prediction block for the encoding or decoding of the video.

47. The computer program product of claim 46, wherein the computer program code further comprising: build a local prediction block for the current coding unit using reference samples on four sides of the current coding unit.

48. The computer program product of claim 46, wherein the reference samples on the four sides of the current coding unit are derived from reconstructed neighboring pixels of the current coding unit and/or a global prediction block.

49. The computer program product of claim 46, wherein the global prediction block is built using the surrounding reference samples of the coding tree unit.
